(19) United States
(12) Patent Application Publication
(10) Pub. No.: US 2004/0012256 A1
(43) Pub. Date: Jan. 22, 2004

(54) Accumulation chamber for a hydraulic vehicle braking system and a hydraulic vehicle braking system

(76) Inventor: Heinz Siegel, Stuttgart (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/333,241

(22) PCT Filed: Jul. 19, 2001
(86) PCT No.: PCT/DE01/02628

(30) Foreign Application Priority Data
Jul. 20, 2000 (DE) 10035218.9

(51) Int. Cl. B60T 8/40

(52) U.S. Cl. 303/116.2

(57) ABSTRACT

A storage chamber for a hydraulic vehicle brake system is embodied as a gas separator, with two fluid connections disposed at different heights. Wheel brake cylinders of an auxiliary force brake system are connected to the fluid connection located at a low level and can be actuated by muscle force if there is a malfunction of an external-energy service brake system. The gas separator keeps gas bubbles away from the fluid connection located at the low level and thereby prevents gas bubbles from getting into the brake fluid of the muscle force auxiliary brake system, in order to assure the function of that system.

### PRIOR ART

The invention relates to a storage chamber for a hydraulic vehicle brake system having the characteristics of the preamble to claim 1 and to a hydraulic vehicle brake system having the characteristics of the preamble to claim 10.

From International Patent Disclosure WO 98/28174, a hydraulic vehicle brake system is known that has a hydraulic external energy source for performing a service braking operation and a master cylinder, actuatable by muscle force, for performing an auxiliary braking operation if a malfunction of the external-energy service brake system occurs. The external energy source acts on all the wheel brake cylinders of the vehicle brake system, while conversely the master cylinder acts only on some of the wheel brake cylinders, namely on front-axle wheel brake cylinders, which upon braking bring about greater deceleration than the other, rear-axle wheel brake cylinders. In a service braking operation, the master cylinder acts as a set-point value transducer for braking force to be generated with wheel brakes, or in other words for wheel brake pressures to be built up in the wheel brake cylinders. In the known vehicle brake system, control of the wheel brake pressures is effected in a manner known per se with brake pressure valve assemblies; preferably each wheel brake cylinder is assigned its own brake pressure valve assembly, so that the wheel brake pressure is individually controllable at each wheel brake.

The known vehicle brake system has one cylinder-piston assembly as a separation device for each of the wheel brake cylinders assigned to the auxiliary brake system, and the piston of this assembly is acted upon in the service braking operation by the external energy source. The piston of the separation device in turn acts on the associated wheel brake cylinder. In the auxiliary braking operation, the master cylinder acts on the wheel brake cylinders without the interposition of the separation device. For the wheel brake cylinders connected to the auxiliary brake system, the separation device separates the brake fluid from the external energy source from the brake fluid of the master cylinder. The purpose of this is to avoid gas bubbles in the brake fluid of the auxiliary brake system. Such gas bubbles can for instance get into the brake fluid of the service brake system from a pressure reservoir downstream of the external energy source. It is also possible for the external energy source to aspirate air and in this way for gas bubbles to get into the brake fluid of the service brake system. The master cylinder actuatable by muscle force has a limited piston travel and thus a limited, positively displaceable brake fluid volume. Since gas bubbles in the brake fluid cause compressibility of the brake fluid, gas bubbles in the brake fluid of the auxiliary brake system diminish its function considerably, or even put the auxiliary brake system out of operation. Gas bubbles in the auxiliary brake system must therefore be avoided, which is why in the known vehicle brake system the separation devices are provided at the wheel brake cylinders connected to the auxiliary brake system.

A disadvantage of the separation devices is that each wheel brake cylinder of the auxiliary brake system must have its own separation device. This makes the vehicle brake system complicated and expensive. The volumes of the separation devices must be adapted to a specific vehicle, which is why different separation devices are needed for various vehicles. This makes the vehicle brake system still more expensive and means that a large amount of parts must be kept on hand. There is also the risk that the wrong separation devices will be installed in a vehicle.

### ADVANTAGES OF THE INVENTION

The storage chamber of the invention having the characteristics of claim 1 avoids the entry of gas bubbles from the brake fluid of the external energy source into the brake fluid of the auxiliary brake system, or into the wheel brake cylinders that strongly decelerate the vehicle, typically the front-axle wheel brake cylinders. The storage chamber of the invention is embodied as a gas separator; in its installation and usage position, it has one fluid connection disposed at a high level and one fluid connection disposed at a low level. The wheel brake cylinders of the auxiliary brake system are connected to the fluid connection disposed at a low level, while the other wheel brake cylinders are connected to the fluid connection at the high level. The storage chamber is connected to the external energy source. Any gas bubbles entering the storage chamber rise upward in the storage chamber or remain at the top and collect at the top of the storage chamber. The storage chamber embodied as a gas separator prevents gas bubbles from reaching the fluid connection located at a low level and thus from getting into the auxiliary brake system connected to that fluid connection.

The storage chamber of the invention thus has the advantage that it keeps gas bubbles away from the brake fluid of the auxiliary brake system. Another advantage is that only one storage chamber is needed for the vehicle brake system. Moreover, the storage chamber of the invention can be embodied with a sufficient volume for all vehicle types, so that different structural sizes of storage chamber are not necessary. An additional advantage of the storage chamber of the invention is that at least in individual embodiments it has no moving parts, making the storage chamber wear-free and malfunction-free. The storage chamber of the invention is simple and inexpensive and can be produced from only a few individual parts.

The dependent claims have various embodiments and refinements of the invention disclosed in claim 1 as their subject. The vehicle brake system of the invention as defined by the characteristics of claim 10 has a storage chamber, embodied as a gas separator, of the above-explained type, which prevents the entry of gas bubbles into the auxiliary brake system.

### DRAWING

The invention will be explained in further detail below in terms of exemplary embodiments shown in the drawing. Shown are:

FIG. 1, a hydraulic circuit diagram of a vehicle brake system of the invention;

FIG. 2, an axial section through a storage chamber of the invention; and

FIG. 3, an axial section through a second exemplary embodiment of a storage chamber of the invention.

### DESCRIPTION OF THE EXEMPLARY EMBODIMENTS

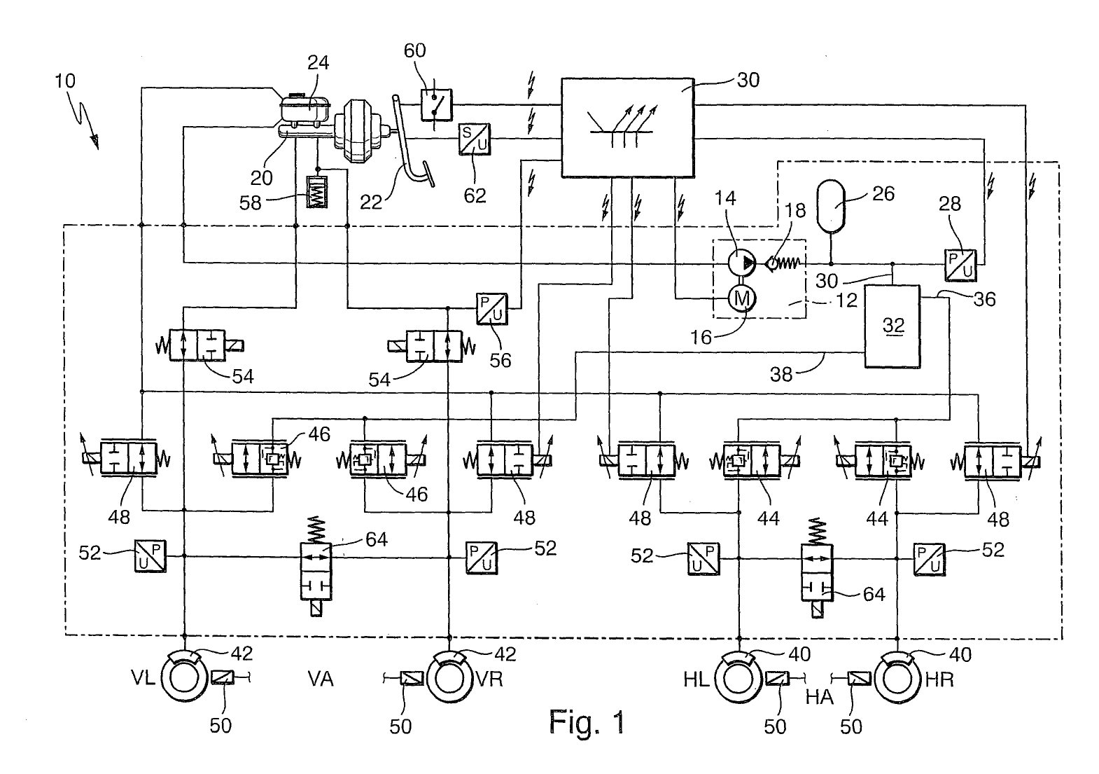

The hydraulic vehicle brake system 10 of the invention, shown in FIG. 1, has an external energy source 12, which includes a hydraulic pump 14 that can be driven by an electric motor 16. Downstream of the hydraulic pump 14 is a check valve 18, which is likewise assigned to the external energy source 12. The external energy source 12 is used to perform service braking operations; the vehicle brake system 10 can therefore be called an electrohydraulic vehicle brake system 10.

The vehicle brake system 10 also has a master cylinder 20, which is actuatable with a foot brake pedal 22, that is, by muscle force. The master cylinder 20 is used to perform auxiliary braking operations in the event of a malfunction of the service brake system. In the case of the service braking operation, the master cylinder 20 serves as a set-point value transducer for a wheel brake pressure that is to be built up with the service brake system. In the case of the service braking operation, the wheel brake pressure is generated solely by the external energy source 12.

The hydraulic pump 14 of the external energy source 12 is connected to a brake fluid reservoir 24 of the master cylinder 20. Connected downstream of the external energy source 12 is a pressure reservoir 26, so that brake fluid under pressure is available at all times for a service braking operation. A pressure sensor 28 is connected to the hydraulic reservoir 26 and furnishes a signal to an electronic control unit 30 of the vehicle brake system 10 of the invention. The control unit 30 switches the electric motor 16 of the hydraulic pump 14 on when a pressure in the hydraulic reservoir 26 drops below a predetermined, lower limit value, and it turns the electric motor 16 off again when the pressure in the pressure reservoir 26 reaches a predetermined, upper limit value.

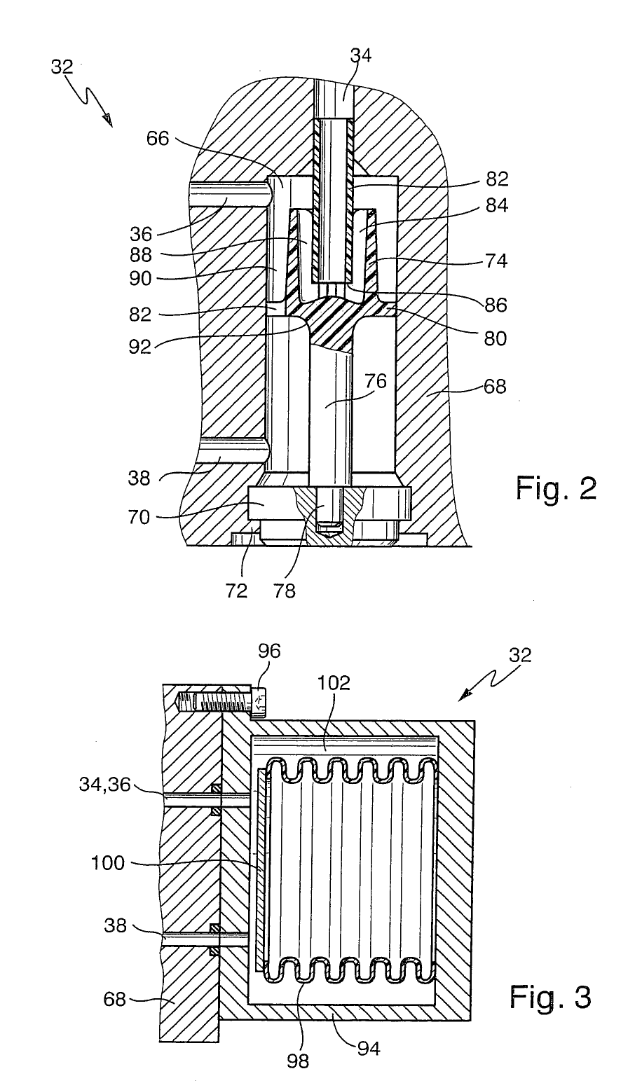

Connected to the external energy source 12 is a storage chamber, which according to the invention is embodied as a gas separator 32. The gas separator 32 has a supply line 34, with which it is connected to the external energy source 12. The gas separator 32, in its usage position, also has one fluid connection 36 disposed at a high level and one fluid connection 38 disposed at a low level. Two wheel brake cylinders 40 are connected to the fluid connection 36 at the high level, and two further wheel brake cylinders 42 of the wheel brake system 10 of the invention are connected to the fluid connection 38 at the low level. The wheel brake cylinders 42 that are connected to the fluid connection disposed at the low level on the gas separator 32 are acted upon by pressure in the event of an auxiliary braking operation with the master cylinder 20. These are front-axle wheel brake cylinders 42. The front-axle wheel brake cylinders 42 bring about the greater deceleration, because of the load on the front axle and the relief of the rear axle of a vehicle during braking. The gas separator 32 prevents gas bubbles, which under some circumstances reach the brake fluid from the hydraulic pump 14 or the pressure reservoir 26, from getting into the fluid connection 38 located at the low level. This prevents gas bubbles from getting into the brake fluid of the front-axle wheel brake cylinders 42, that is, from getting into the auxiliary brake system. The structure and function of the gas separator 32 of the invention will be explained hereinafter in conjunction with FIGS. 2 and 3.

The rear-axle wheel brake cylinders 40 are connected to the fluid connection 36, disposed at the high level, of the gas separator 32 via brake pressure buildup valves 44. The front-axle wheel brake cylinders 42 are connected to the fluid connection 38, located at the low level, of the gas separator 32 via pressure buildup valves 46. The pressure buildup valves 44, 46 are embodied as 2/2-way magnet valves that are closed in their basic position when without current. Via brake pressure reduction valves 48, the wheel brake cylinders 40, 42 are connected to a common return line that leads to the brake fluid reservoir 24 of the master cylinder 20. The pressure reduction valves 48 are embodied as 2/2-way magnet valves that are open when in their basic position without current. Differential pressure valves are integrated into the pressure buildup valves 44, 46 and have the task of limiting a maximum pressure in the reservoir, for instance in the event of failure of the pressure sensor 28. Intrinsically, one differential pressure valve is sufficient and can be either integrated into one of the pressure reduction valves 48 or provided as a separate valve. In the exemplary embodiment of the invention shown, four structurally identical pressure reduction valves with integrated differential pressure valves are used, and therefore there are also four differential pressure valves. The pressure buildup valves 44, 46 and the pressure reduction valves 48 are controlled by the electronic control unit 30. The pressure buildup valve 44, 46 assigned to one wheel brake cylinder 40, 42, together with the pressure reduction valve 48 assigned to the wheel brake cylinder 40, 42, forms a brake pressure valve assembly 44, 46, 48, with which a wheel brake pressure in the associated wheel brake cylinder 40, 42 can be controlled. To increase the wheel brake pressure, the pressure buildup valve 44, 46 is opened and the pressure reduction valve 48 is closed. To lower the wheel brake pressure in the associated wheel brake cylinder 40, 42, the pressure buildup valve 44, 46 is closed and the pressure reduction valve 48 is opened. To keep the wheel brake pressure in a wheel brake cylinder 40, 42 constant, the pressure buildup valve 44, 46 assigned to it and the pressure reduction valve 48 assigned to it are closed. This is known per se and will not be addressed in further detail here. It is also possible for both of the pressure buildup valves and pressure reduction valves 44, 46, 48 assigned to one wheel brake cylinder 40 to be replaced by a 3/3-way magnet valve (not shown). Also in a manner known per se, the brake pressure valve assemblies 44, 46, 48 make individual-wheel slip control possible to avoid the locking of a vehicle wheel during braking and to prevent a driven vehicle wheel from spinning upon acceleration (functions known as anti-lock braking and traction control). Stabilization of the vehicle upon cornering is also possible, in a manner known per se, with the brake pressure valve assemblies 44, 46, 48, by targeted braking of one or more vehicle wheels, with the particular goal of avoiding skidding of the vehicle.

To detect wheel slip or spinning vehicle wheels, each vehicle wheel is assigned one wheel rotation sensor 50, which furnishes a signal to the electronic control unit 30. One pressure sensor 52 is also connected to each wheel brake cylinder 40, 42, so that the wheel brake pressure can be measured and compared with a set-point value.

The master cylinder 20 is embodied as a dual-circuit master cylinder. The two front-axle wheel brake cylinders 42 are connected to it, with the interposition of one separation valve 54 each. The separation valves 54 are embodied as 2/2-way magnet valves that are open in their currentless basic position. In the case of a service braking operation in which the energy required for braking is made available by the external energy source 12, the separation valves 54 are closed; that is, the master cylinder 20 is disconnected from the wheel brake cylinders 40, 42. In the case of a malfunction of the service brake system, which can be ascertained from an absent or inadequate brake pressure buildup by means of the pressure sensor connected to the external energy source 12, the separation valves 54 remain open, and by depression of the brake pedal 22 by muscle force, a brake pressure in the front-axle wheel brake cylinders 42 is built up with the master cylinder 20. That is, an auxiliary braking operation by muscle force is performed.

When the main brake system is not malfunctioning, the master cylinder 20 acts as set-point transducer for the brake pressure. A pressure sensor 56 is connected to one circuit of the dual-circuit master cylinder 20, and with this sensor a pressure built up in the master cylinder 20 when the brake pedal 22 is depressed can be measured and acts as a set-point value for the wheel brake pressures to be built up in the wheel brake cylinders 40, 42. The wheel brake pressures can be different in different wheel brake cylinders 40, 42 and in particular can differ from the pressure in the master cylinder 20. In the normal situation, a higher wheel brake pressure is set in the front-axle wheel brake cylinders 42 than in the rear-axle wheel brake cylinders 40.

Since in a service braking operation the separation valves 54 are closed and therefore no brake fluid can be positively displaced from the master cylinder 20 into the vehicle brake system 10, a pedal travel simulator 58 is connected to one brake circuit of the master cylinder 20. The pedal travel simulator 58 is embodied as a cylinder-piston unit, with a spring-actuated piston. When the brake pedal 22 is depressed with the separation valves 54 closed, brake fluid is positively displaced out of the master cylinder 20 into the pedal travel simulator 58, whose spring brings about a customary pedal-force/travel dependency.

A so-called brake light switch 60 and a pedal travel sensor 62 are connected to the brake pedal 22. With the brake light switch 60, it can be ascertained whether the brake pedal 22 is depressed; with the pedal travel sensor 62, the travel, that is, the distance by which the brake pedal 22 is depressed, can be ascertained. The pedal travel sensor 62 can also be used as a set-point value transducer for the wheel brake pressure to be set in the wheel brake cylinders 40, 42; it is redundant to the pressure sensor 56 connected to the master cylinder 20.

The two wheel brake cylinders 40, 42 of each vehicle axle are connected to one another via an axle valve 64. The axle valve 64 is embodied as a 2/2-way magnet valve that is open in its currentless basic position. The axle valve 64 normally remains open during braking; that is, in braking the same wheel brake pressure prevails in the wheel brake cylinders 40, 42 of one vehicle axle. If the wheel brake pressure in one wheel brake cylinder 40, 42 is to be controlled individually, then the axle valve 46 of the corresponding vehicle axle is closed, and the brake pressure control is done in the manner already described, using the pressure buildup valve 44, 46 and the pressure reduction valve 48 that is assigned to the applicable wheel brake cylinder 40, 42. This kind of individual-wheel brake pressure regulation is required for instance if the grip of the surface under the wheels is different on the left and right sides of the vehicle, and for anti-lock braking or traction control and for vehicle dynamics control.

FIG. 2 shows a storage chamber for a hydraulic vehicle brake system. The storage chamber is embodied according to the invention as a gas separator 32. The gas separator 32 is embodied as a blind bore 66 in a hydraulic block 68 of a vehicle brake system. Other hydraulic components of the vehicle brake system, not shown in FIG. 2, are accommodated and hydraulically connected to one another in the hydraulic block 68. The hydraulic components are in particular the magnet valves 44, 46, 48, 54, 64; the hydraulic pump 14 with its electric motor 16; and the pressure sensors 28, 52, 56 of the vehicle brake system 10 of the invention. For the sake of clarity, in FIG. 2 only a fragment of the hydraulic block 68 surrounding the gas separator 32 is shown and at the same time forms a housing of the gas separator 32.

The blind bore 66 is closed in pressuretight fashion with a closure cap 70, which is inserted on an orifice side into the blind bore 66 and is held in place and sealed off in pressureproof fashion by an encompassing bead 72. The fluid connections 36, 38 of the gas separator 32 to which the rear-axle wheel brake cylinders 40 and the front-axle wheel brake cylinders 42 are connected are embodied as bores in the hydraulic block 68 that discharge radially into the blind bore 66. The fluid connection 36 disposed at the high level, to which the rear-axle wheel brake cylinders 40 are connected, discharges at the top into the blind bore 66, and the lower fluid connection 38 to which the front-axle wheel brake cylinders 42 are connected discharges at the bottom into the blind bore 66. The terms top and bottom and upper and lower refer to an installation and usage position of the gas separator 32; it is important that the fluid connection 38 disposed at the low level discharge into the blind bore 36 at a sufficient distance from an upper end thereof to assure that any gas bubbles entering the blind bore 36 cannot get into the fluid connection 38 disposed at the low level.

A cup 74 open at the top is made from plastic and is inserted into the blind bore 66. The cup 74 has a support 76, which has a peg 78 on its end with which it is pressed into a blind bore in the closure cap 70. The cup 74 is secured in the blind bore 66 in this way. An encompassing collar protrudes radially from a region of a bottom of the cup 74; it rests on a wall of the blind bore 66 and thereby holds the cup 74 coaxially in the blind bore 66. The collar forms a partition 80 that subdivides the gas separator 32 into one upper part and one lower part. The partition 80 is provided with openings 82 through which the brake fluid can pass.

The gas separator 32 is connected to the hydraulic pump 14 of the external energy source 12 of the hydraulic vehicle brake system 10 of the invention via a third fluid connection 34. The third connection 34 is embodied as a bore in the hydraulic block 68 that discharges coaxially from above into the blind bore 66. A pipe segment 82 is pressed into the bore that forms the third fluid connection 34 and plunges into the cup 74 to near its bottom. Four longitudinally extending ribs 84 protrude radially inward from one wall of the cup 74. Via the ribs 84, the cup 74 and the pipe segment 82 are radially braced on one another. The ribs 84 have steps 86 on which the pipe segment 82 is seated with its end edge toward the bottom of the cup 74. Between the ribs 84 in the interior of the cup 74, one wall of the cup 74, and the pipe segment 82 there are interstices through which brake fluid can flow out of the pipe segment 82 into the blind bore 66 and vice versa. These interstices have a large cross-sectional area and form a calming path 88, in which the brake fluid has a low flow speed. An interstice between the wall of the cup 74 and the blind bore 66 also has an interstice of large cross section, which likewise forms a calming path 90 with a low brake fluid flow speed.

The function of the storage chamber embodied according to the invention as a gas separator 32 is as follows: Any air bubbles entering the gas separator 32 from the hydraulic pump 12 or the pressure reservoir 26 connected to it (FIG. 1) through the third fluid connection 34 and the pipe segment 82 rise upward in the blind bore 66 and collect at its upper end. This keeps air bubbles away from the fluid connection 38 disposed at the low level. This prevents such air bubbles from reaching the front-axle wheel brake cylinders 42, assigned to the auxiliary brake system, of the vehicle brake system 10 of the invention that are connected to the fluid connection 38 disposed at the low level. Because of the reduced flow speed of the brake fluid in the calming paths 88, 90, the brake fluid is prevented from entraining air bubbles downward in the blind bore 66 as far as the region of the fluid connection 38 disposed at the low level.

In the region of its bottom, the cup 74, on its outside and underside toward the closure cap 70, is embodied with a rounded feature 92. Its purpose is to allow air bubbles that reach the lower region of the blind bore 66 to rise and collect at the upper end of the blind bore 66. The gas separator 32 is embodied such that it has no downward-oriented faces below the upper end of the blind bore 66 where air bubbles could collect.

FIG. 3 shows a second exemplary embodiment of a storage chamber, embodied according to the invention as a gas separator 32. The storage chamber has a hollow-cylindrical housing 94, which is screwed with screws 96 to a side face of a hydraulic block 68 of a hydraulic vehicle brake system. A metal bellows 98 is inserted into the housing 94 and is closed with a closure cap 100. Thus a gas cushion is trapped in the bellows 98. The storage chamber is accordingly a hydraulic reservoir actuated by gas pressure. The bellows 98 forms a movable separation element of the gas separator 32, which divides an interior of the housing 94 into a variable storage volume 102, surrounding the bellows 98, and the gas volume enclosed in the bellows 98. For connection of the gas separator 32 to the vehicle brake system 10, two bores are made in the hydraulic block 68, which continue through a wall of the housing 94 of the gas separator 32 and discharge into its variable storage volume 102. The bores are made one above the other, in the installation and usage position of the gas separator 32. The bore located higher forms the fluid connection 36 disposed at the high level, to which the rear-axle wheel brake cylinders 40 of the vehicle brake system 10 are connected. The lower bore forms the fluid connection 38 disposed at the low level, to which the front-axle wheel brake cylinders 42 are connected. The fluid connection 36 disposed at the high level at the same time forms the third fluid connection 34, by which the gas separator 32 is connected to the hydraulic pump 14. In principle, the function of the gas separator 32 shown in FIG. 3 is the same as the function of the gas separator 32 shown in FIG. 2. Any air bubbles that may enter the gas separator 32 of the invention, shown in FIG. 3, from the hydraulic pump 14 or the pressure reservoir 26 rise upward in the storage volume 102, thus preventing air bubbles from getting into the fluid connection 28 at the low level and thus into the brake fluid flowing into the front-axle wheel brake cylinders 42.

In the claims:

14. In a hydraulic vehicle brake system having at least two wheel brake cylinders which, to perform a service braking operation, can be acted upon by a hydraulic external energy source, having a master cylinder, actuatable by muscle force, with which for performing an auxiliary braking operation at least one of the wheel brake cylinders can be acted upon, the improvement wherein the vehicle brake system (10) comprises
a gas separator (32) connected downstream of the external energy source (12);
a storage chamber in the gas separator (32) for hydraulic fluid, the gas separator (32) having one fluid connection (36) for at least one wheel brake cylinder (40) and a second fluid connection (38) for at least one other wheel brake cylinder (42),
one fluid connection (36) in the gas separator (32) being disposed higher than the other fluid connection (38) in the use position when in use in a vehicle brake system; and
the master cylinder (20) acting on the wheel brake cylinder or wheel brake cylinders (42) whose fluid connection (38) is disposed at a lower level on the gas separator (32).

15. The hydraulic vehicle brake system of claim 14, wherein the master cylinder (20) that can be actuated by muscle force does not act on all the brake circuits.

16. The hydraulic vehicle brake system of claim 14, wherein the storage chamber has a variable storage volume (102).

17. The hydraulic vehicle brake system of claim 15, wherein the storage chamber has a variable storage volume (102).

18. The hydraulic vehicle brake system of one of claim 14, wherein the storage chamber has a movable separation element (98) dividing the storage chamber into the storage volume (102) and a volume separated from it.

19. The hydraulic vehicle brake system of one of claim 15, wherein the storage chamber has a movable separation element (98) dividing the storage chamber into the storage volume (102) and a volume separated from it.

20. The hydraulic vehicle brake system of one of claim 18, wherein the separation element is a bellows (96).

21. The hydraulic vehicle brake system of one of claim 19, wherein the separation element is a bellows (96).

22. The hydraulic vehicle brake system of one of claim 14, wherein the storage chamber has a third fluid connection (34).

23. The hydraulic vehicle brake system of one of claim 15, wherein the storage chamber has a third fluid connection (34).

24. The hydraulic vehicle brake system of one of claim 14, wherein the storage chamber has a calming path (88, 90) with a large flow cross section between the first fluid connection (36) and the second fluid connection (38).

25. The hydraulic vehicle brake system of one of claim 16, wherein the storage chamber has a calming path (88, 90) with a large flow cross section between the first fluid connection (36) and the second fluid connection (38).

26. The hydraulic vehicle brake system of one of claim 18, wherein the storage chamber has a calming path (88, 90) with a large flow cross section between the first fluid connection (36) and the second fluid connection (38).

27. The hydraulic vehicle brake system of claim 14, further comprising a cup (74) open at the top in the usage position of the gas separator (32) disposed in the storage chamber, the third fluid connection (34, 82) discharging into this cup.

28. The hydraulic vehicle brake system of claim 24, further comprising a cup (74) open at the top in the usage position of the gas separator (32) disposed in the storage chamber, the third fluid connection (34, 82) discharging into this cup.

29. The hydraulic vehicle brake system of claim 14, further comprising a partition (80) disposed in the storage chamber and having at least one fluid connection (82), the gas separator 32 in its usage position subdividing the storage chamber into an upper part and a lower part that communicate with one another through the fluid connection (82), the fluid connection (136) discharging into the upper part and the fluid connection (238) discharging into the lower part.

30. The hydraulic vehicle brake system of claim 14, wherein in the usage position of the gas separator (32), faces (92) of the storage chamber located below the first fluid connection (36) are embodied extending obliquely upward in such a way that gas bubbles can rise along them upward in the direction of the first fluid connection (36).

31. The hydraulic vehicle brake system of claim 30, wherein the master cylinder (20) actuatable by muscle force does not act on all the brake circuits.

32. The hydraulic vehicle brake system of claim 31, wherein the master cylinder (20) acts on the wheel brake cylinder or wheel brake cylinders (42) whose fluid connection (38) is disposed at a lower lever on the gas separator (32).
